(19) United States
(12) Patent Application Publication
(10) Pub. No.: US 2010/0052603 A1
(43) Pub. Date: Mar. 4, 2010

(54) Rechargeable Batteries

(76) Inventors: Jordan T. Bourilkov, Stamford, CT (US); David N. Klein, Southbury, CT (US)

Correspondence Address: FISH & RICHARDSON P.C., P.O. BOX 1022, MINNEAPOLIS, MN, 55440-1022, US

(21) Appl. No.: 12/202,680

(22) Filed: Sep. 2, 2008

(51) Int. Cl. H02J 7/00

(52) U.S. Cl. 320/101

(57) ABSTRACT

A rechargeable battery is provided comprising a battery housing (e.g., a can), a rechargeable battery cell within the housing, and a charger circuit comprising one or more solar cell(s) disposed on the battery housing and in electrical communication with the rechargeable battery cell. Methods of recharging batteries using solar energy are also provided.

### TECHNICAL FIELD

This invention relates to rechargeable batteries.

### BACKGROUND

The run-times of small electronics are limited by the capacity of the batteries used to power these devices. Generally, the battery packs are recharged by connecting the batteries and/or the devices to chargers that receive power from external AC or DC power sources. In some cases, rechargeable batteries are charged by chargers that are solar powered, e.g., by a string of solar cells.

Most battery chargers require some user planning and interaction to charge the batteries prior to use in devices, thus making rechargeable batteries less convenient than primary (disposable) batteries which are ready to use without charging.

### SUMMARY

Disclosed herein are rechargeable batteries that include an integral solar charger, e.g., a solar cell incorporated in the battery label. This allows the batteries to be recharged without the need for a separate charger or user interaction, just by keeping the batteries exposed to light for a period of time sufficient for charging.

In some cases, the user can keep the required number of batteries in a device, and the same number of replacement batteries in a location exposed to light so that the replacement batteries will recharge and be ready for use when needed. The in-device and replacement batteries can thus be cycled back and forth as needed. This usage pattern works particularly well with devices with intermittent use and infrequent battery replacement (once a month or less), e.g., flashlights, digital cameras, remote controls, toys and the like.

In one aspect, the invention features a rechargeable battery comprising: (a) a battery housing; (b) one or more rechargeable battery cells within the housing; and (c) a charger circuit comprising one or more solar cell(s) disposed on the battery housing and in electrical communication with the rechargeable battery cell.

Some implementations may include one or more of the following features. The circuit further comprises a diode in series with the one or more solar cell(s). The solar cells are disposed on a label attached to the battery housing, for example printed on or attached to the label. Alternatively, the solar cells may be disposed directly on a surface of the housing. The circuit further comprises printed leads connecting the solar cells to terminals of the battery cell. The circuit includes from 3 to 5 solar cells. The solar cells are in the form of rings disposed circumferentially around the battery housing. The circuit further comprises an additional diode in series to prevent dark current. The solar cell(s) produce a total voltage of about 1.5 to 3.5V. The solar cell(s) produce a total current of about 0.1 to 30 mA. The label comprises a transparent or translucent portion. For example, the label may comprise a multi-layer laminate having a translucent or transparent layer. In some cases, the multi-layer laminate comprises a second layer underlying the translucent or transparent layer and the solar cell(s) are provided on the second layer. The multi-layer laminate may in some cases include a plurality of layers underlying the translucent or transparent layer, and the solar cell(s) may be provided on two or more of the underlying layers for enhanced efficiency.

In another aspect, the invention features a method of charging a rechargeable battery. The method includes: (a) providing a battery comprising a battery housing and a rechargeable battery cell within the housing; (b) providing one or more solar cell(s) on the battery housing, the solar cells being in electrical communication with the rechargeable battery cell; and (c) exposing the battery to light sufficient for the solar cells to generate electricity.

Some implementations may include one or more of the following features. The method further includes providing a diode in series with the solar cell(s). Providing the solar cell(s) comprises printing the solar cell(s) on a battery label. The battery housing may have any desired shape, for example a shape selected from the group consisting of rectangular, cylindrical, oval, and prismatic. The method further includes printing one or more other device(s) on the battery label, for example, fuel gauges, power check devices, printed inductive pickup coils (e.g., for wireless charging), printed RFIDs (e.g., for wireless battery identification), and cycle life indicators.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a diagrammatic side view of a rechargeable battery.

FIG. 2 is a schematic of the charger circuit.

Like reference symbols in the various drawings indicate like elements.

### DETAILED DESCRIPTION

The batteries disclosed herein are provided with an integral solar charger. The charger is part of the battery, avoiding the need for a separate charger. The solar charger includes one or more solar cells, preferably a plurality of solar cells connected in series, disposed on the battery surface. Generally, the battery includes a label, and the solar cells are provided on the label, either by printing them on the label or attaching them to the label.

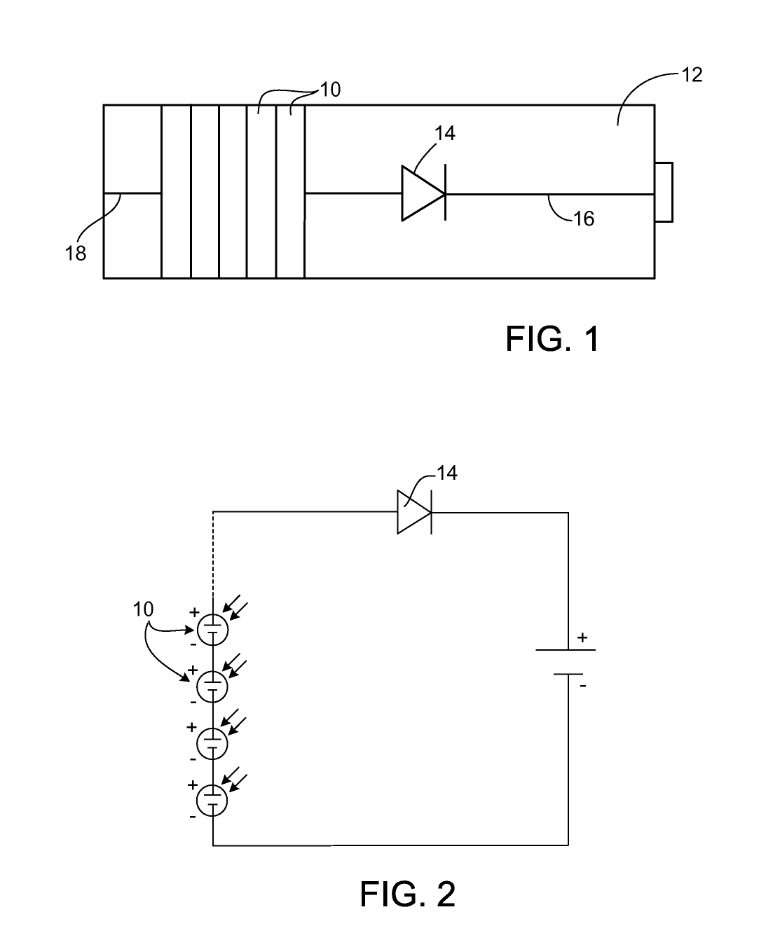

In some implementations, as shown for example in FIG. 1, the solar cells are printed as rings 10 on the battery label 12 which is mounted on an underlying battery housing or “can” (not shown). These ring-shaped solar cells are connected in series. The ring shape is generally preferred, as it allows battery charging regardless of the direction of incident light or the orientation of the battery during charging. The label may include, for example, 3 to 5 solar cells. A diode 14 is also printed on the label, and connected in series with the solar cells. The solar cells and diode are in the form of plastic electronics (also referred to in the art as “organic photovoltaics” or “printable electronics”) or in any desired flexible, thin sheet form. Printed wires 16, 18, connect the diode and the solar cells, respectively, to the battery terminals.

The surface area of the circuit generally covers only a portion of the label, leaving room for graphics and information that are normally provided on the battery label. For example, for an AA cell having a label area of 20 cm², the circuit may cover about 10 cm² or less. As shown in FIG. 1, in some implementations the circuit is disposed along the length of the battery on one side, while the graphics and text (not shown) are disposed along a portion of the length of the battery on the opposite side. In some implementations the label material includes a translucent or transparent layer or area, allowing the circuit and graphics/lettering to co-exist in the same area of the battery label.

For example, the label may be a laminated multi-layer film, with a transparent or translucent layer bearing the label graphics and text, and an underlying layer having one or more solar cell(s) printed on it. Conversely, the solar cell may be printed on a transparent or translucent film and may itself be semi-transparent, so that underlying text and/or graphics can be seen through the solar cell. Alternatively, the label may be a single layer transparent or translucent film, with the battery information printed on one side and the solar cell(s) printed on the other.

The circuit, shown in FIG. 2, is preferably tailored so that the solar cell voltage in any light (indoors or outdoors) minus the voltage drop across the diode is substantially equal to or higher than the optimum trickle-charging voltage of the rechargeable battery (for example, for a single NiMH cell, 1.4 to 1.5V). Thus, V_{solar cell}−Vf_{diode}>=Vch_{battery}.

According to the above equation, for a diode voltage drop between 0.3 and 0.7V, the combined voltage of the solar cells should generally be around or above 2V. This can be achieved, for example, using three to five Silicon solar cells connected in series (e.g., 0.4 to 0.7V/cell depending on the light conditions and the load).

There is minimal to no risk of over-charging the battery because of the very low current (0.1 to 20 mA) of the solar cell (for example a AA NiMH cell can tolerate indefinitely a charging current of up to 50 mA). For the same reason there is no need of a current limiting resistor in the circuit. The diode prevents reverse (dark) current from discharging the rechargeable battery through the solar cell.

The circuit can be connected to the battery terminals by printed wires on the label, as discussed above, with conductive glue providing a connection to the positive terminal where the label ends. The battery case itself is generally the negative terminal of the cell.

The charge time for a NiMH AA cell (2000 mAh typical capacity low self-discharge types) is in some implementations a week or less in direct sunlight. Charging will take longer with less available light, for example 3 to 5 weeks in a bright room and up to a year indoors and away from light sources.

A number of embodiments of the invention have been described. Nevertheless, it will be understood that various modifications may be made without departing from the spirit and scope of the invention.

For example, the solar cells may have a form other than rings. In some implementations, the solar cells may be in the form of a flexible solar module. Such modules include a flexible plastic sheet carrying an array of thin-film printed solar cells.

In some implementations, an additional diode or transistor switch may be provided in series to prevent or minimize discharge due to dark current. In such cases, an additional solar cell may be included to compensate for the voltage lost across the diode.

Any desired number of solar cells may be used, and the total voltage and surface area of the cells adjusted based on the desired trickle charge for a particular cell size and charge rate.

In some implementations, the solar cells, and/or other components of the circuit, are attached to the label rather than printed on the label. Moreover, if the battery housing (can) does not include a label the circuit may be printed directly on or attached directly to the exterior of the battery housing.

In some implementations the battery label may be, for example, a heat shrink tubing.

Accordingly, other embodiments are within the scope of the following claims.

What is claimed is:

1. A rechargeable battery comprising:
a battery housing;
one or more rechargeable battery cells within the housing; and
a charger circuit comprising one or more solar cell(s) disposed on the battery housing and in electrical communication with the rechargeable battery cell.

2. The battery of claim 1 wherein the circuit further comprises a diode in series with the one or more solar cell(s).

3. The battery of claim 1 wherein the solar cells are disposed on a label attached to the battery housing.

4. The battery of claim 3 wherein the solar cells are printed on the label.

5. The battery of claim 1 wherein the circuit further comprises printed leads connecting the solar cells to terminals of the battery cell.

6. The battery of claim 1 wherein the circuit includes from 3 to 5 solar cells.

7. The battery of claim 1 wherein the solar cells are in the form of rings disposed circumferentially around the battery housing.

8. The battery of claim 2 wherein the circuit further comprises an additional diode in series to prevent dark current.

9. The battery of claim 1 wherein the solar cell(s) produce a total voltage of about 1.5 to 3.5V.

10. The battery of claim 1 wherein the solar cell(s) produce a total current of about 0.1 to 30 mA.

11. The battery of claim 3 wherein the solar cells are attached to the label.

12. The battery of claim 3 wherein the label comprises a transparent or translucent portion.

13. The battery of claim 12 wherein the label comprises a multi-layer laminate having a translucent or transparent layer.

14. The battery of claim 13 wherein the multi-layer laminate comprises a second layer underlying the translucent or transparent layer and the solar cell(s) are provided on the second layer.

15. The battery of claim 14 wherein the multi-layer laminate comprises a plurality of layers underlying the translucent or transparent layer, and the solar cell(s) are provided on two or more of the underlying layers.

16. A method of charging a rechargeable battery comprising:
providing a battery comprising a battery housing and a rechargeable battery cell within the housing;
providing one or more solar cell(s) on the battery housing, the solar cells being in electrical communication with the rechargeable battery cell; and
exposing the battery to light sufficient for the solar cells to generate electricity.

17. The method of claim 16 further comprising providing a diode in series with the solar cell(s).

18. The method of claim 16 wherein providing the solar cell(s) comprises printing the solar cell(s) on a battery label.

19. The method of claim 16 wherein the battery housing has a shape selected from the group consisting of rectangular, cylindrical, oval, and prismatic.

20. The method of claim 16 further comprising printing one or more other device(s) on the battery label.

21. The method of claim 20 wherein the other devices are selected from the group consisting of fuel gauges, power check devices, printed inductive pickup coils, printed RFIDs, and cycle life indicators.
